(19) United States
(12) Patent Application Publication
(10) Pub. No.: US 2011/0205120 A1
(43) Pub. Date: Aug. 25, 2011

(54) Monopulse Beamformer for Electronically Switched Antennas

(75) Inventor: Daniel R. Culkin, Cazenovia, NY (US)

(73) Assignee: SRC, Inc., North Syracuse, NY (US)

(21) Appl. No.: 12/708,750

(22) Filed: Feb. 19, 2010

(51) Int. Cl. H01Q 3/00

(52) U.S. Cl. 342/374

(57) ABSTRACT

A method and system for monopulse beamforming for electronically switched antennas is presented. Inputs of selected antenna elements from a phased array antenna are summed into subsets of elements which are then combined into sum and delta beams. 2:1 switches in a shoelace arrangement allow the combination of signals from half of the selected aperture first at common phase and then at pi phase difference to from the sum and delta beams. The method allows for reduced weight, controls, and processing when compared to prior art.

### BACKGROUND OF THE INVENTION

1. Field of the Invention

The present invention relates to a method and system for beamforming, and more specifically, to a method and system of monopulse beamforming for electronically switched antennas.

2. Description of the Related Art

Radar systems use antennas to transmit and receive electromagnetic (“EM”) signals in various ranges of the EM band. While traditional radar systems used moving parts to physically point the antenna towards different target fields, many modern radar systems use an electronically scanned array (“ESA”) in which a central EM signal is split into multiple paths, with the signal phase and amplitude controlled and manipulated for the purpose of beam steering and beamforming.

Beamforming changes the directionality of an antenna array by controlling the phase and amplitude of the signal at each antenna element, thereby creating an intentional pattern of interference in the wavefront during transmission. When receiving, information from the elements are combined so as to increase the antenna gain in a desired direction. In communications, beamforming is used to direct the antenna at a signal source in order to reduce interference and improve signal quality. In radar systems, beamforming is used to direct the antenna to scan an environment for signals and/or determine the direction of a signal source.

Monopulse beamforming is commonly used in modern radar systems for target angle determination. According to this method, a receive signal is split by the radar into two signals, the summation beam (“Σ”) and the difference beam (“Δ”). The two signals are then compared to each other to determine the direction of the target.

Although beamforming systems are ubiquitous in radar systems, there is a continued need for beamforming systems and methods that require reduced footprint (in hardware and in processing) compared to known beamforming systems.

### BRIEF SUMMARY OF THE INVENTION

It is therefore a principal object and advantage of the present invention to provide a monopulse beamformer.

It is another object and advantage of the present invention to provide a monopulse beamformer of a reduced weight and volume.

It is yet another object and advantage of the present invention to provide an improved method of beamforming that can be used with a wide variety of electronically steered radar systems that utilize switched element steering configurations for steering, in which the antenna elements in use are switched depending on the direction of the desired beam pointing.

It is yet another object and advantage of the present invention to have application to reduce the weight, volume, and complexity required of monopulse beamforming for curved antennas that utilize element switching for the purpose of beam pointing.

Other objects and advantages of the present invention will in part be obvious, and in part appear hereinafter.

In accordance with the foregoing objects and advantages, the present invention provides a method for monopulse beamforming for an electronically switched antenna. As an initial step, the beamforming method provides a signal from one or more antenna elements arranged within an antenna array. The system selects a subset of all the signals received by the antenna array, where the subset is comprised of signals from antenna elements that are consecutively spaced within the antenna array. The amplitude of the first subset of signals is adjusted, and the phase of the first subset is adjusted. The adjusted subset of signals is split into a first subset and a second subset, where the signals within each subset are provided by consecutive antenna elements. The first split subset of signals are summed to create a first output, and the second split subset of signals are summed to create a second output. The system then creates a first beam by adding the first output and the second output, and creates a second beam by subtracting the first output and the second output.

A second aspect of the present invention provides antenna elements that are arranged in a curved orientation within said antenna array.

A third aspect of the present invention provides a monopulse beamformer system with significantly reduced weight and volume for an electronically switched antenna. The system comprises an antenna array with more than one antenna element, where each of the antenna elements provides a signal. The system further comprises more than one element selection switches which select a first subset of the signals received by the antenna elements. The amplitude of each of the signals within the subset is shifted by an amplitude shifter, and the phase is shifted by a phase shifter. An antenna split switch matrix splits the selected signals into a first subset of signals and a second subset of signals. One or more sum elements sum the first subset into a first output and the second subset into a second output. The system further comprises a beamformer that creates a first beam by adding the first output and said the second output, and creates a second beam by subtracting the first output and the second output.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a high-level flow diagram illustrating one embodiment of the invention;

FIG. 2 is a schematic representation of a beamforming system according to one embodiment of the present invention; and

FIG. 3 is a schematic representation of an associated antenna according to one embodiment of the present invention.

### DETAILED DESCRIPTION OF THE INVENTION

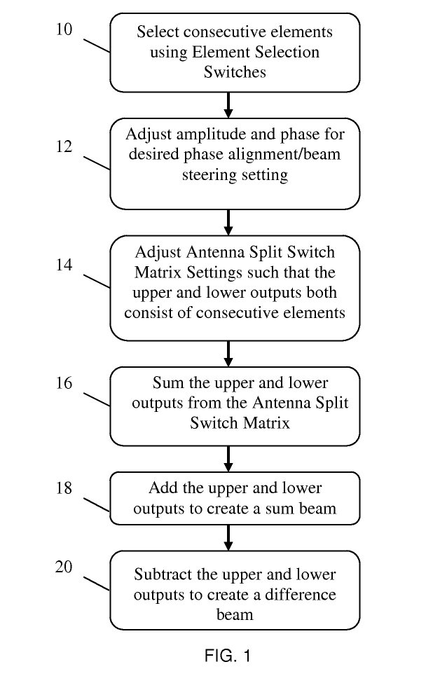

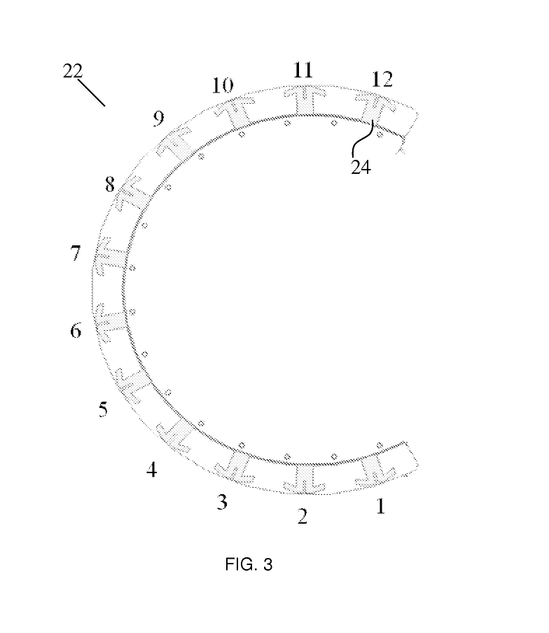

Referring now to the drawings, wherein like reference numerals refer to like parts throughout, there is seen in FIG. 1 a high-level flow diagram illustrating one embodiment of the invention. As an initial step 10 in the system, an aperture, or area presented to the signal, is selected by the radar system. In a preferred embodiment, the antenna layout is identical to or similar to the antenna layout 22 depicted in FIG. 3. In this embodiment, the curved antenna contains a total of twelve antenna elements 24, although those skilled in the art would easily recognize that any number of antenna elements are possible.

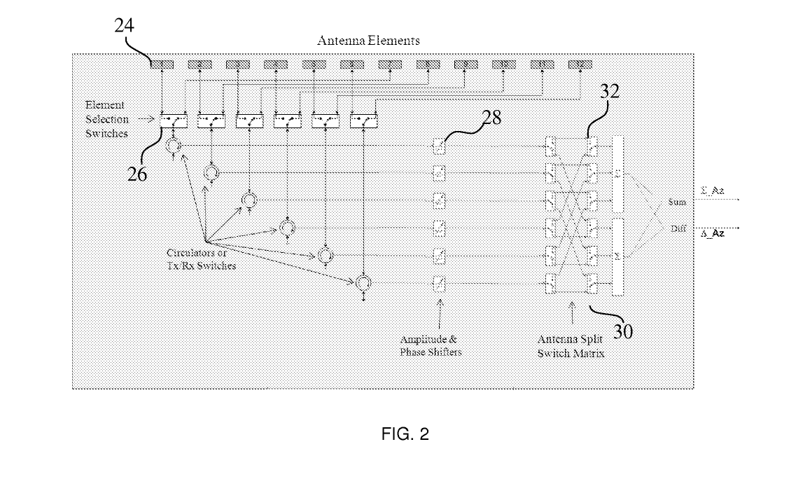

FIG. 2 depicts a schematic representation of the beamforming system according to one embodiment, and in that representation six consecutive antenna elements 24 are chosen through the settings of the element selection switches 26. The aperture selection can depend upon a wide variety of factors, including but not limited to pre-programmed radar algorithms, the three-dimensional topography of the scanned area, and user-defined programming, among many others.

In step 12 of FIG. 1, the inputs from the selected antenna elements 24 are adjusted in phase and in amplitude by amplitude and phase shifters 28. This step is performed in order to steer the beam from the antenna in the desired direction and place appropriate element amplitude weights for the desired gain and beam characteristics, as well as to achieve the desired beam main lobe shape, delta beam null quality, and beam side lobe levels and structure, among other things.

In step 14, the antenna split switch matrix 30 is set such that the upper three and lower three outputs 32 consist of consecutive antenna elements. For example, if antenna elements #3, 4, 5, 6, 7, 8 in FIG. 2 are selected in step 10, then phase shifters 28 will receive signals from antenna elements #6, 5, 4, 3, 8, 7 as read from top to bottom. To split the antenna into halves, the settings of antenna split switch matrix 30 must be set such that elements #6, 7, 8 are sent to the upper three outputs, while elements #3, 4, 5 are sent to the lower three outputs.

In step 16, the upper three and lower three outputs of the antenna split switch matrix are summed to form two signals, which, in a preferred embodiment, are referred to as the upper signal and the lower signal. In step 18, the upper signal and lower signal are summed without any phase adjustment, thereby creating a sum, or “Σ” beam. In step 20, the upper signal and the lower signal are subtracted, thereby creating a difference, or “Δ” beam. In other words, one of the two signals has a “pi” phase shift applied to it, and the two signals are summed to create a difference, or “Δ,” beam

The Σ and Δ beams can then be utilized by any downstream process or component known to those skilled in the art. The Σ and Δ beams from multiple curved antennas can be combined to form a three dimensional antenna.

In a preferred embodiment, when compared to an existing comparable antenna configuration, the monopulse beamforming system of the present invention reduces radar components from five circuit boards (including three switch boards and two azimuth beamformers) to a single board, thereby reducing the component count and weight of the entire radar system. In other embodiments, the monopulse beamforming method can significantly reduce the processing speed, weight, heat generation, energy requirements, or other criteria known to those skilled in the art to be utilized by a radar system.

The monopulse beamforming method and system according to the present invention can be used in a wide variety of radar formats, including but not limited to any electronically scanned radar system using switch-matrix style scanning.

Although the present invention has been described in connection with a preferred embodiment, it should be understood that modifications, alterations, and additions can be made to the invention without departing from the scope of the invention as defined by the claims.

What is claimed is:

1. A method of beamforming for an electronically switched antenna, the method comprising:
providing a plurality of signals from a plurality of antenna elements in an antenna array, wherein each of said plurality of antenna elements in said antenna array is adapted to provide at least one of said plurality of signals;
selecting a first subset of said plurality of signals, wherein the first subset of said plurality of signals is provided by antenna elements that are consecutively spaced within said antenna array;
adjusting the amplitude of said first subset of the plurality of signals;
adjusting the phase of said first subset of the plurality of signals;
splitting said first subset of signals into a second subset of signals and a third subset of signals, wherein said second subset of signals comprises signals provided by consecutive antenna elements, and said third subset of signals comprises signals provided by consecutive antenna elements;
summing said second subset of signals to create a first output;
summing said third subset of signals to create a second output;
creating a first beam; and
creating a second beam.

2. The method of claim 1, wherein said first beam is created by adding said first output to said second output.

3. The method of claim 1, wherein said first beam is created by summing said first subset of said plurality of signals.

4. The method of claim 1, wherein said second beam is created by subtracting said first output from said second output.

5. The method of claim 1, wherein said second beam is created by subtracting said second output from said first output.

6. The method of claim 1, wherein the step of creating a second beam comprises the following steps:
shifting said first output by one half cycle of signal phase; and
adding the shifted first output to said second output.

7. The method of claim 1, wherein the amplitude of said first subset is adjusted such that a desired sum and delta beam direction and pattern characteristic is achieved.

8. The method of claim 1, wherein the phase of said first subset is adjusted to align the phase front from the elements to constructively sum in the desired beam direction.

9. The method of claim 1, wherein said first output is a sum beam.

10. The method of claim 1, wherein said second output is a difference beam.

11. The method of claim 1, wherein said plurality of antenna elements are arranged in a curved orientation within said antenna array.

12. A beamformer system for an antenna array, the beamformer system comprising:
an antenna array comprising a plurality of antenna elements and adapted to provide a plurality of signals, wherein each of said plurality of antenna elements is adapted to provide at least one of said plurality of signals;
a plurality of element selection switches, said plurality of element selection switches adapted to select a first subset of said plurality of signals;
an amplitude shifter, wherein said amplitude shifter is adapted to shift the amplitude of the selected signals within said first subset;
a phase shifter, wherein said phase shifter is adapted to shift the phase of the selected signals within said first subset;
an antenna split switch matrix, wherein said antenna split switch matrix is adapted to split said first subset of signals into a second subset of signals and a third subset of signals;
a first sum element, the first sum element adapted to sum said second subset of signals to create a first output;
a second sum element, the second sum element adapted to sum said third subset of signals to create a second output; and
a beamformer, the beamformer adapted to create a first beam by adding said first output and said second output, and further adapted to create a second beam.

13. The beamformer system of claim 12, wherein said beamformer is adapted to create said second beam by subtracting said first output from said second output.

14. The beamformer system of claim 12, wherein said beamformer is adapted to create said second beam by subtracting said second output from said first output.

15. The beamformer system of claim 12, wherein said beamformer is adapted to create said second beam by shifting said first output by one half cycle of signal phase and adding the shifted first output to said second output.

16. The beamformer system of claim 12, wherein the selected signals within the first subset are provided by antenna elements that are consecutively spaced within the antenna array.

17. The beamformer system of claim 12, wherein said second subset of signals comprises signals provided by consecutive antenna elements, and said third subset of signals comprises signals provided by consecutive antenna elements.

18. The beamformer system of claim 12, wherein said amplitude shifter adjusted so as to achieve desired beam pattern characteristics.

19. The beamformer system of claim 12, wherein said phase shifter adjusted so as to align the phase front of the element contributions to constructively sum in the desired beam direction.

20. The beamformer system of claim 12, wherein said plurality of antenna elements are arranged in a curved orientation within said antenna array.
